(19) United States
(12) Patent Application Publication
(10) Pub. No.: US 2025/0094781 A1
(43) Pub. Date: Mar. 20, 2025

(54) MULTI-TASK GATING FOR MACHINE LEARNING SYSTEMS

(71) Applicant: QUALCOMM Incorporated, San Diego, CA (US)

(72) Inventors: Babak EHTESHAMI BEJNORDI, Amsterdam (NL); Gaurav KUMAR, Ambala City (IN); Amelie Marie Estelle ROYER, Amsterdam (NL); Eduardo ESTEVES, San Diego, CA (US); Tijmen Pieter Frederik BLANKEVOORT, Amsterdam (NL); Mohsen GHAFOORIAN, Diemen (NL)

(21) Appl. No.: 18/468,873

(22) Filed: Sep. 18, 2023

(51) Int. Cl. G06N 3/0464; G06N 3/084

(52) U.S. Cl. CPC G06N 3/0464; G06N 3/084

(57) ABSTRACT

Systems and techniques are described herein for training and using multitask machine learning models. For example, a computing device can obtain training data for a first task in a layer in a neural network; perform, based on a determination from a first gating mechanism, the shared function on shared features of the training data using at least one shared channel to generate a shared feature map; perform, based on the determination from the first gating mechanism, the first task-specific function on first task-specific features of the training data using at least one first task-specific channel to generate a first task-specific feature map; generate an output for the first task-specific branch based on performing the shared function on the shared features and performing the first task-specific function on the first task-specific features; and update at least one parameter of the first gating mechanism based on the output.

### FIELD

The present disclosure generally relates to training and using (during inference) multi-task learning machine learning models. For example, aspects of the present disclosure relate to systems and techniques for implementing gating in a convolutional neural network to dynamically learn gating patterns.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for implementing gates in a convolutional neural network to dynamically learn gating patterns. According to some examples, an apparatus for training a neural network to perform at least one task is provided. The apparatus includes at least one memory and at least one processor coupled to the at least one memory. The at least one processor is configured to: obtain training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch; perform, based on a determination from the first gating mechanism, the shared function on the shared features of the training data for the first task using at least one of the one or more shared channels to generate a shared feature map; perform, based on the determination from the first gating mechanism, the first task-specific function on the first task-specific features of the training data for the first task using at least one of the one or more first task-specific channels to generate a first task-specific feature map; generate an output for the first task-specific branch based on performing the shared function on the shared features of the training data and performing the first task-specific function on the first task-specific features of the training data; and update at least one parameter of the first gating mechanism based on the output.

In another illustrative example, a method for training a neural network to perform at least one task is provided. The method includes: obtaining training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch; performing, based on a determination from the first gating mechanism, the shared function on the shared features of the training data for the first task using at least one of the one or more shared channels to generate a shared feature map; performing, based on the determination from the first gating mechanism, the first task-specific function on the first task-specific features of the training data for the first task using at least one of the one or more first task-specific channels to generate a first task-specific feature map; generating an output for the first task-specific branch based on performing the shared function on the shared features of the training data and performing the first task-specific function on the first task-specific features of the training data; and updating at least one parameter of the first gating mechanism based on the output.

In another illustrative example, a non-transitory computer-readable storage medium is provided comprising instructions stored thereon which, when executed by at least one processor, cause the at least one processor to: obtain training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch; perform, based on a determination from the first gating mechanism, the shared function on the shared features of the training data for the first task using at least one of the one or more shared channels to generate a shared feature map; perform, based on the determination from the first gating mechanism, the first task-specific function on the first task-specific features of the training data for the first task using at least one of the one or more first task-specific channels to generate a first task-specific feature map; generate an output for the first task-specific branch based on performing the shared function on the shared features of the training data and performing the first task-specific function on the first task-specific features of the training data; and update at least one parameter of the first gating mechanism based on the output.

In another illustrative example, an apparatus is provided for training a neural network to perform at least one task. The apparatus includes: means for obtaining training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch; means for performing, based on a determination from the first gating mechanism, the shared function on the shared features of the training data for the first task using at least one of the one or more shared channels to generate a shared feature map; means for performing, based on the determination from the first gating mechanism, the first task-specific function on the first task-specific features of the training data for the first task using at least one of the one or more first task-specific channels to generate a first task-specific feature map; means for generating an output for the first task-specific branch based on performing the shared function on the shared features of the training data and performing the first task-specific function on the first task-specific features of the training data; and means for updating at least one parameter of the first gating mechanism based on the output.

In another illustrative example, an apparatus for performing at least one task is provided. The apparatus includes at least one memory and at least one processor coupled to the at least one memory. The at least one processor is configured to: receive input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch; perform the shared function on shared features of the input data for the first task using at least one of the one or more shared channels of the shared branch to generate a shared feature map; perform the first task-specific function on first task-specific features of the input data using at least one of the one or more first task-specific channels associated with the first task-specific function to generate a first task-specific feature map; and generate an output for the first task-specific branch based on performing the shared function on the shared features of the input data and performing the first task-specific function on the first task-specific features of the input data.

In another illustrative example, a method for performing at least one task is provided. The method includes: receiving input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch; performing the shared function on shared features of the input data for the first task using at least one of the one or more shared channels of the shared branch to generate a shared feature map; performing the first task-specific function on first task-specific features of the input data using at least one of the one or more first task-specific channels associated with the first task-specific function to generate a first task-specific feature map; and generating an output for the first task-specific branch based on performing the shared function on the shared features of the input data and performing the first task-specific function on the first task-specific features of the input data.

In another illustrative example, a non-transitory computer-readable storage medium is provided comprising instructions stored thereon which, when executed by at least one processor, cause the at least one processor to: receive input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch; perform the shared function on shared features of the input data for the first task using at least one of the one or more shared channels of the shared branch to generate a shared feature map; perform the first task-specific function on first task-specific features of the input data using at least one of the one or more first task-specific channels associated with the first task-specific function to generate a first task-specific feature map; and generate an output for the first task-specific branch based on performing the shared function on the shared features of the input data and performing the first task-specific function on the first task-specific features of the input data.

In another illustrative example, an apparatus is provided for performing at least one task. The apparatus includes: means for receiving input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch; means for performing the shared function on shared features of the input data for the first task using at least one of the one or more shared channels of the shared branch to generate a shared feature map; means for performing the first task-specific function on first task-specific features of the input data using at least one of the one or more first task-specific channels associated with the first task-specific function to generate a first task-specific feature map; and means for generating an output for the first task-specific branch based on performing the shared function on the shared features of the input data and performing the first task-specific function on the first task-specific features of the input data.

In some aspects, one or more of apparatuses described herein include a mobile device (e.g., a mobile telephone or so-called “smart phone” or other mobile device), a wireless communication device, a vehicle or a computing device, system, or component of the vehicle, an extended reality device (e.g., a virtual reality (VR) device, an augmented reality (AR) device, or a mixed reality (MR) device), a wearable device, a personal computer, a laptop computer, a server computer, a camera, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 2C illustrates an example of a convolutional neural network, in accordance with some examples;

FIG. 3A illustrates an example use case for multitasking convolutional neural networks in accordance with some examples;

FIG. 3B illustrates an example use case for multitasking convolutional neural networks in accordance with some examples;

FIG. 4 is a block diagram illustrating an example neural network in accordance with some examples;

FIG. 5 is a block diagram illustrating an example multi-task learning model having multiple layers in accordance with some examples;

FIG. 6A illustrates example experimental results comparing performances of a conventional single task learning model, a conventional or standard multitask learning model, and gated multitask learning models in accordance with some examples;

FIG. 6B illustrates example experimental results comparing performances of a conventional single task learning model, a conventional or standard multitask learning model, and gated multitask learning models in accordance with some examples;

FIG. 7A is a graph illustrating the experimental results of FIG. 6A in accordance with some examples;

FIG. 7B a graph illustrating the experimental results of FIG. 6A in accordance with some examples;

FIG. 8 illustrates a method for training a neural network to perform at least one task in accordance with some examples;

FIG. 9 illustrates a method for performing at least one task using a neural network in accordance with some examples;

FIG. 10 is a block diagram illustrating an example of a deep learning network, in accordance with some examples;

FIG. 11 is a block diagram illustrating an example of a convolutional neural network, in accordance with some examples; and

FIG. 12 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the disclosure. However, it will be apparent that various aspects and examples may be practiced without these specific details. The figures and description are not intended to be restrictive.

The ensuing description provides exemplary aspects and examples only, and is not intended to limit the scope, applicability, or configuration of the disclosure. Rather, the ensuing description of the exemplary aspects and examples will provide those skilled in the art with an enabling description for implementing aspects and examples of the disclosure. It should be understood that various changes may be made in the function and arrangement of elements without departing from the scope of the application as set forth in the appended claims.

As noted above, machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

Enabling a machine learning system to perform multiple functionalities or tasks (which can be referred to as a multi-task machine learning system or model) may require running multiple models simultaneously and is a recurrent requirement in many different domains, including extended reality (XR), autonomous driving, etc. In some cases, a multi-task machine learning system may mutual or shared information (e.g., features) for the different functionalities or tasks. However, training and inferring independent models can not only prevent the machine learning system from best leveraging existing mutual information for these tasks but also incur redundant compute, making these models inefficient and/or impractical to run. Such an issue may be apparent in many applications, such as edge-device applications (e.g., XR applications, among others), which may involve devices have limited processing or computing bandwidth.

One common approach is to design a multi-task machine learning system (e.g., a neural network system or model) so that multiple tasks share a backbone network model (e.g., a feature extraction neural network model or encoder), but each task uses a specialized head (e.g., different neural network decoder model) to generate a respective output for each task. While such a solution can mitigate issues regarding compute inefficiency, the solution can face other challenges. For instance, co-training such models can result in challenging training dynamics. In some examples, a first task may be an easier task for the machine learning system to perform as compared to one or more other task(s), which can result in the model converging faster for the first task or having different loss types/scales. Such an issue can result in gradients of the first task overwhelming and/or interfering with the other task(s). These training challenges can result in less accurate models. For example, there may be tension between the efficiency from fully sharing features and the accuracy from fully independent training of separate models.

In some cases, other design variables may cause additional challenges. For example, shareable features between tasks may not be obvious a-priori. In another example, not all layers of a machine learning system (e.g., a neural network) have the same behavior as other layers. Consequently, approaches that make hard design choices make strong assumptions on which layers may be more beneficial to share representations and on which layers the models could segregate. Moreover, bandwidth of a representation is set or fixed regardless of the dynamics of co-training of the different given tasks.

Conventional multi-task optimization methods aim to improve multitask learning (MTL) by balancing training dynamics of different tasks by unifying the task losses magnitudes or aligning the gradient magnitude or directions of various tasks. As another example, some conventional task grouping methods learn to group tasks with high affinity together and learn the tasks jointly, while separating the learning of low affinity tasks. However, even tasks that appear to have high affinity together can have unexpected results, and similarly, tasks that appear to have low affinity may have better results. For example, a conventional multitask learning model can be trained with multiple tasks such as surface normal estimation, depth estimation, and semantic segmentation. Surface normal estimation and depth estimation may have high affinity. For example, surface normal can be mathematically derived from depth estimation. Such high affinity may allow the two mathematically similar surface normal and depth estimation tasks to leverage many of the same features. However, a conventional multitasking learning model trained with these three tasks experienced a significant decrease in performance for surface normal estimation, but the depth estimation and semantic segmentation performed better.

Systems, apparatuses, processes (also referred to as methods), and computer-readable media (collectively referred to as “systems and techniques”) are described herein that provide gating mechanisms for a machine learning system (e.g., a multi-task neural network model) to dynamically learn an optimal feature sharing and segregation scheme (e.g., during training of the machine learning system). The machine learning system can include a shared branch including shared layers and one or more task-specific (or specialized) branches, with each task-specific branch including task-specific layers. In some cases, the systems and techniques can adapt a capacity of the machine learning system, such as by pruning excess channels of shared or task-specific layers (e.g., where additional sharing is occurring) and expanding desired channels (e.g., when more task-specific functions or specialization is needed).

As noted above, the systems and techniques provide the use of gating mechanisms. The gating mechanisms allow the machine learning system to dynamically learn, per layer, which features are to be shared and which features are to be specialized for a given task. In some aspects, task-specific (or specialized) layers are trained only with task-specific losses to avoid gradients from one task from potentially interfering with other tasks. A gating mechanism is a learnable neural network component that, for each task-specific feature map in a next layer, determines whether features will be from a task-specific branch or a shared branch. The task-specific feature map can then be processed by a task-specific function and a shared function. The learnable gating mechanism can thus provide dynamic convergence to an optimal multi-task architecture for a set of tasks without costly population-based training and/or strong prior assumptions or knowledge.

In some cases, the functionality of the gating mechanism can be task-dependent. In such cases, after training, the gating mechanisms can statistically use the learned gating patterns to create a simpler network architecture for inference. In some aspects, for deployment (or inference) of the machine learning system, the gating mechanism can be removed from the machine learning system, and channels can be selected for the machine learning system based on the learned gating patterns. In some examples, the machine learning system can remove or prune unselected, unnecessary, and/or excess channels. Thus, at inference time, the machine learning system has a mechanism to convert to be or to generate a simple or plain network without gating functionality to avoid more complicated routing logic. Such an architecture can allow the machine learning system to learn and optimize how to share, segregate, and prune features based on the number and type of tasks at hand in a data-driven manner.

The learned gating patterns can optimize MTL models by statistically selecting between shared features and task-specific features, while also dynamically allocating channels for the features to the various tasks. In other words, one task may be allocated more throughput compared to another task to improve the overall performance of the model across a subset or all of the tasks.

Various aspects of the present disclosure will be described with respect to the figures.

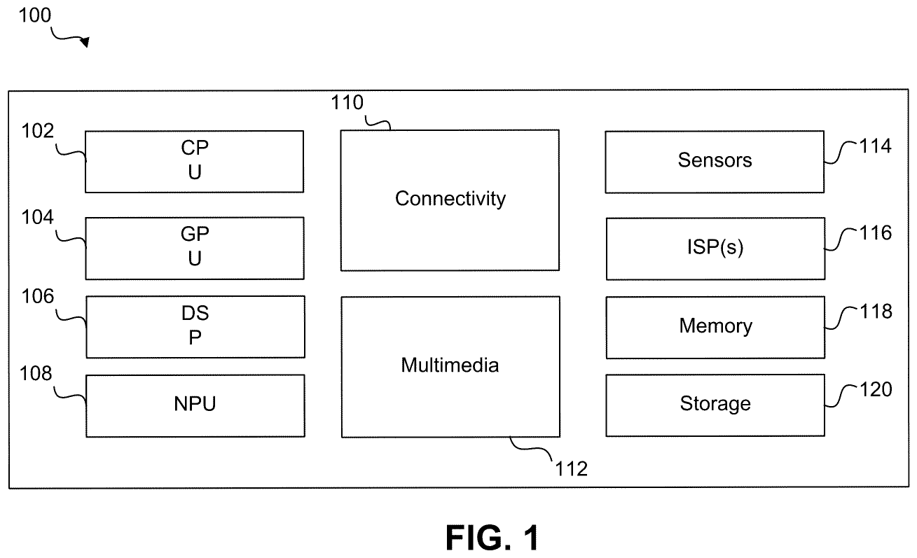

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include one or more sensors 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving an output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

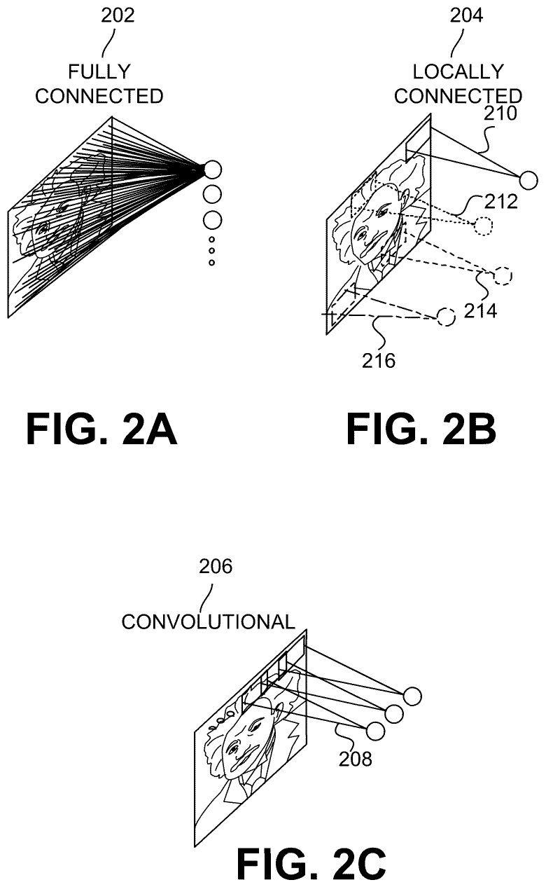

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer.

FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

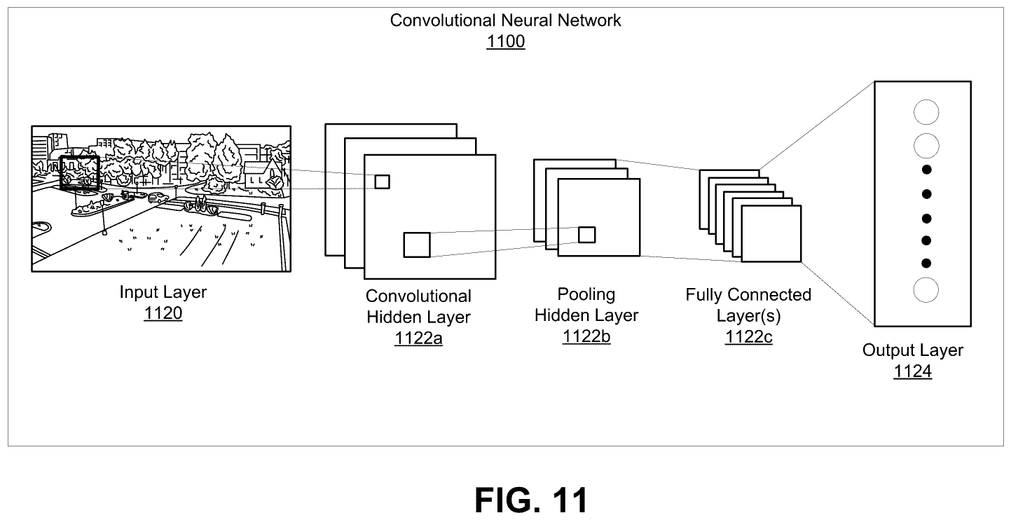

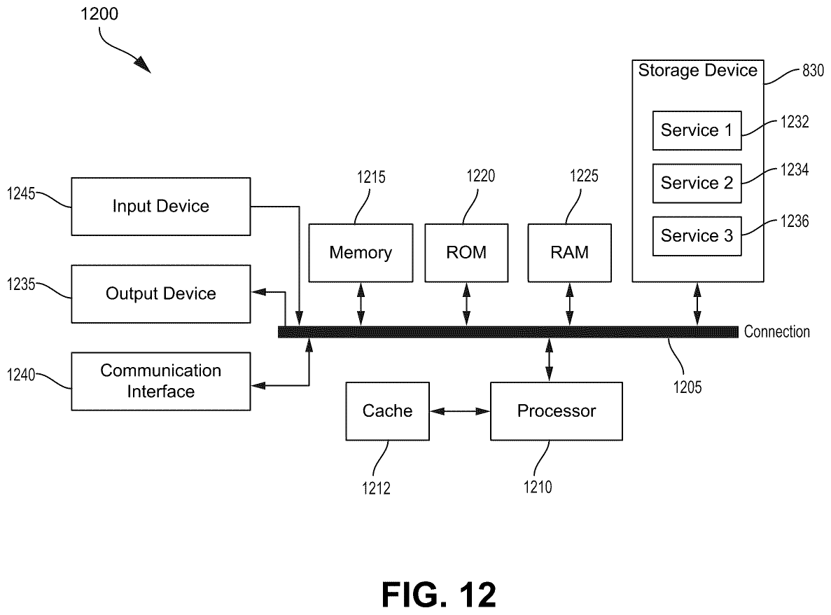

An example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure. An illustrative example of a deep learning network is described in greater depth with respect to the example block diagram of FIG. 11. An illustrative example of a convolutional neural network is described in greater depth with respect to the example block diagram of FIG. 12.

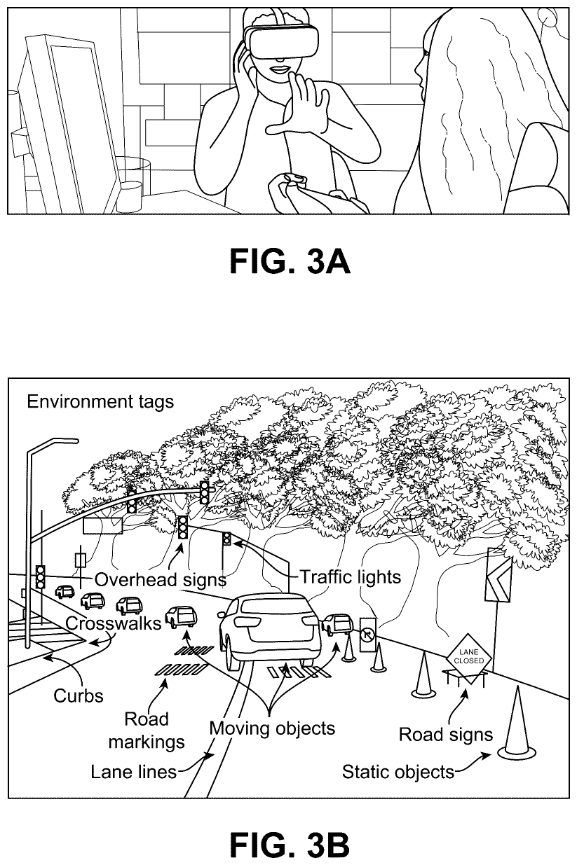

As noted previously, some neural networks are designed to perform multiple tasks, and can be referred to as a multi-task neural network. FIG. 3A and FIG. 3B depict two examples use cases for multi-task convolutional neural networks. For example, FIG. 3A illustrates a person using a virtual reality headset. The virtual reality headset can, for example, leverage convolutional neural networks to create or recreate 3D objects, track motion, track objects and/or images, segment images, localize the virtual reality headset, etc.

FIG. 3B illustrates an example image of a roadway as, for example, observed by one or more sensors of an autonomous vehicle. The computing system of the autonomous vehicle can leverage convolutional neural networks to detect and track objects such as pedestrians and other vehicles, perform road segmentation, detect lane markings, traffic signs and/or lights, and weather conditions, among other functionalities.

Conventionally, multiple tasks are performed by multiple models (e.g., each functionality is performed using a different model from the other functions). Separate models are attractive because training the models independently can lead to more accurate results. On the other hand, deploying multiple models can be computationally inefficient because the models can rely on some of the same information for these tasks.

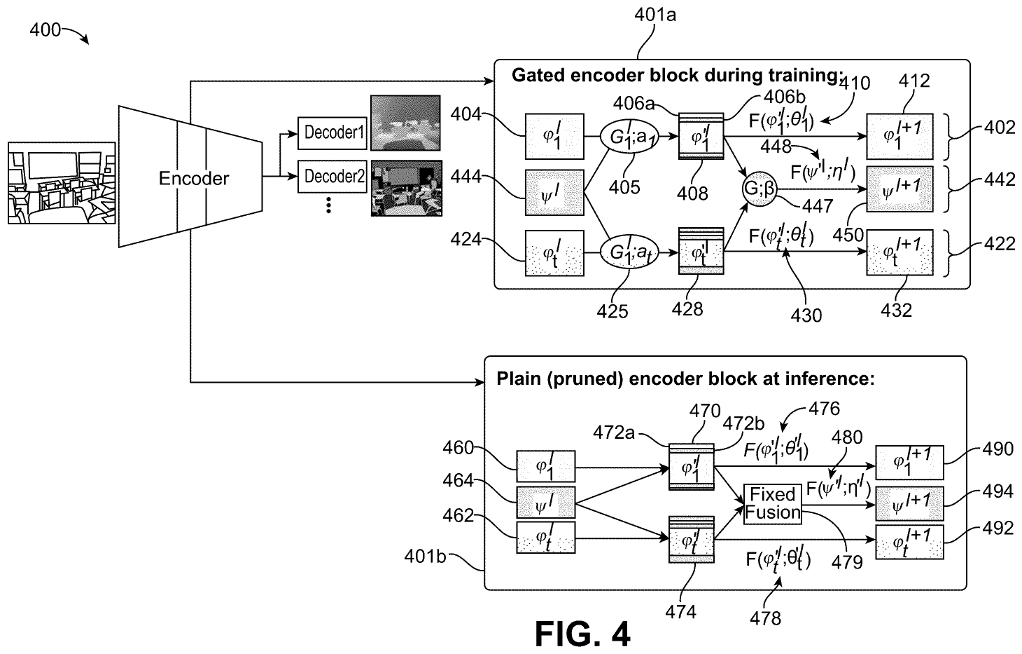

As described previously, systems and techniques are described for providing gating mechanisms for a machine learning system (e.g., a multi-task neural network model) to dynamically learn an optimal feature sharing and segregation scheme (e.g., during training of the machine learning system). FIG. 4 is a block diagram illustrating an example forward pass of a neural network 400 during training. The neural network 400 is an illustrative example of a machine learning system that utilizes the gating mechanisms described herein.

The neural network 400 can include an encoder block during training 401a that is configured to obtain or receive input data (e.g., training data) in each of the first task specific branch 402, the second task specific branch 422, and the shared branch 442. The training or input data can include first task specific features 404, second task specific features 424, and shared features 444. The features 404, 424, and 444 are stored in respective channels (corresponding to channels of respective layers of the first task specific branch 402, the second task specific branch 422, and the shared branch 442). For instance, as shown in FIG. 4, the first task specific features 404 are included in one or more first task specific channels 406a, 406b. In some examples, one first task specific feature 404 can be represented in a first channel 406a and another first task specific feature 404 can be represented in a second channel 406b.

Certain features from the features 404, 424, and 444 can be determined using gating mechanisms (shown in FIG. 4 as “squeeze gating”) and included in a first task-specific feature map 408 and in a second task specific feature map 428. The features of the first task-specific feature map 408 can be processed using a first task specific function 410 of the first task specific branch 402 and by and a shared function 448 of the shared branch 442. The features of the first task-specific feature map 408 can be processed using a second task specific function 430 of the second task specific branch 422 and by the shared function 448 of the shared branch 442.

The training or input data can include first task specific features 404, second task specific features 424, and shared features 444. The features are stored in respective channels. For example, the first task specific features 404 are represented in one or more first task specific channels 406a, 406b. More specifically, one first task specific feature 404 can be represented in a first channel 406a and another first task specific feature 404 can be represented in a second channel 406b.

The one or more first task specific channels 406a, 406b are associated with one or more other first task specific channels for other layers. For example, one first task specific feature 404 represented in the first channel 406a of the first task specific channels can be included in the first task-specific feature map 408, and can be processed using the first task specific function 410 to generate a first extracted features 412 represented in another first task specific channel (e.g., in a subsequent layer). The neural network 400 can thus perform the first task specific function 410 on the first task specific features 404 to generate the first extracted features 412. In some examples, the first task specific function 410 can include convolutions and/or transformations performed on features of the first task-specific feature map 408 to generate the first extracted features 412.

The second task specific features 424 are also represented in one or more second task specific channels. The one or more second task specific channels are associated with one or more other second task specific channels for other layers. For example, one second task specific feature 424 represented in a first channel of the one or more second task specific channels can be included in the second task specific feature map 428, and can be processed using the second task specific function 430 to generate a second extracted features 432.

Similarly, the shared features 444 are represented in one or more shared channels. The one or more shared channels respectively correspond with the one or more first task specific channels 406a, 406b and the one or more second task specific channels. For example, the first channel 406a of the one or more first task specific channels respectively corresponds to a first channel of the one or more shared channels. As another example, the second channel 406b of the one or more first task specific channels respectively corresponds to a second channel of the one or more shared channels. In some cases, the total number of first task specific channels of the first task specific features 404 is the same as the total number of second task specific channels of the second task specific features 424 and also the same as total number of shared channels for the shared features 444.

As noted previously, the first task specific features 404 and the shared features 444 can be squeeze gated using a first gating mechanism 405 to generate the first task-specific feature map 408. The first gating mechanism 405 is configured to concatenate or otherwise combine certain features from the first task specific features 404 and certain features from the shared features 444 to generate the first task-specific feature map 408. For example, the first gating mechanism can be configured to select, determine, or otherwise set channels of the first task specific features 404 and the shared features 444 to be active or inactive. A channel is active when the channel is selected by the first gating mechanism 405 to provide the respective feature forward (e.g., to be processed by the first task specific function 410 and the shared function 448). A channel is determined to be inactive when the channel is not selected by the first gating mechanism 405 to provide a feature forward. Accordingly, the first gating mechanism 405 is configured to concatenate or otherwise combine active and/or selected channels from the first task specific features 404 and the shared features 444 of selected shared channels 447 to generate the first task-specific feature map 408.

Similarly, the second task specific features 424 and the shared features 444 can be squeeze gated using a second gating mechanism 425 to generate a second task specific feature map 428. A second gating mechanism 425 is configured to concatenate or otherwise combine certain features from the second task specific features 424 and certain features from the shared features 444 to generate the second task specific feature map 428. For example, the second gating mechanism 425 can be configured to select, determine, or otherwise set channels of the second task specific features 424 and the shared features 444 to be active or inactive. As discussed above, a channel is active when the channel is selected by the second gating mechanism to provide the respective feature forward (e.g., to be processed by the second task specific function 430 and the shared function 448) and a channel is determined to be inactive when the channel is not selected to provide a feature forward. Accordingly, the second gating mechanism 425 is configured to concatenate or otherwise combine active and/or selected channels from the second task specific features 424 and the shared features 444 of selected shared channels 447 to generate second task specific feature map 428.

In some aspects, a gating mechanism 405, 425 (also referred to as a gating module or gating engine) includes a gate for each set of corresponding shared channels and first task-specific channels. For example, each set of corresponding shared channels and first task-specific channels has one shared channel and one first task-specific channel, such that there is a corresponding counterpart for each of the shared channels and for each of the first task-specific channels. Additionally, each shared channel and corresponding first task-specific channel are both associated with the same feature or a feature that is within a threshold difference therebetween. Accordingly, each gate can make a binary decision to utilize either the shared channel or the first task-specific channel for a particular feature to be included in the first task-specific feature map 408. The selected channel is then set as the active channel and the other channel is set as inactive. As discussed above, inactive channels can be pruned or removed from the neural network 400 (e.g., when the neural network 400 is deployed for inference).

The first task-specific feature map 408 and the second task specific feature map 428 can then be processed using one or more of the first task specific function 410, second task specific function 430, and shared function 448. For example, the first task-specific feature map 408 can be processed by the first task specific function 410 and/or the shared function 448, while the second task specific feature map 428 can be processed by the second task specific function 430 and/or the shared function 448.

Channels of the first task-specific feature map 408 are processed by the first task specific function 410 to generate corresponding channels in the first extracted features 412. Similarly, channels of the second task specific feature map 428 are processed by the second task specific function 430 to generate corresponding channels in second extracted features 432.

Channels of the first task-specific feature map 408 and the second task specific feature map 428 can also be processed by the shared function 448 to generate corresponding channels in shared extracted features 450.

The first extracted features 412 can then be combined with the shared extracted features 450 to generate a first output feature map, The first output feature map can be output to another layer (e.g., a hidden layer, pooling hidden layer, output layer, etc.) and/or a decoder head configured to intake or receive the first output feature map and generate another output (e.g., a segmentation mask, a classification result, or other output).

In some examples, a MTL model can be trained and deployed as follows. Given T tasks, a goal is to learn a multi-task model parameterized by shared parameters η and task-specific parameters θₜ by minimizing the following multitask learning objective:

$$J ( η , {\{ {θ}_{t} \}}_{t = 1}^{T} ) = {\sum }_{t = 1}^{T} {ω}_{t} ( X , {Y}_{i} ; η , {θ}_{t} )$$

where t represents an individual task, X and Yₜ are the input data and corresponding labels for task t, and [symbol] represents the loss function for each task t. ωₜ is a weighting coefficient which allows for balancing the importance of each task in the overall objective.

A multitasking learning (MTL) model of the presently disclosed technology learns to balance the use of task specific features and shared features for a given task. The neural network 400 can be configured to be a MTL as described herein.

Let ψ^{l}∈R^{C1×Wl×Hl} and φₜ^{l}∈R^{C}^{^{l}}^{×W}^{^{l}}^{×H}^{^{l}} represent the shared and task-specific features at layer l of our multi-task network, respectively. The gating module Gₜ^{l} of task t at layer l performs a channel gating operation by interleaving the channels in ψ^{l} and φ^{l}t. The output φₜ^{l÷1} can therefore be defined as:

$$\begin{matrix}ϕ {′}_{t}^{l} = {G}_{t}^{l} ( {α}_{t}^{l} ) ⊙ {ϕ}_{t}^{l} + ( 1 - {G}_{t}^{l} ( {α}_{t}^{l} ) ) ⊙ {ψ}^{l} \\ {ϕ}_{t}^{l + 1} = F ( ϕ {′}_{t}^{l} ; {θ}_{t}^{l} )\end{matrix}$$

where αₜ^{l}∈R^{C}^{ⁱ} denotes the learnable parameters for channel-wise gating of the features for task t at layer l. F is a learnable (non-linear) transformation such as a convolutional or a transformer block. The output ψ^{l+1} for the shared branch is computed as follows:

$$\begin{matrix}{ψ′}^{l} = {\sum }_{t = 1}^{T} soft {max}_{t} ( {β}_{t}^{l} ) ⊙ ϕ {′}_{t}^{l} \\ {ψ}^{l + 1} = F ( {ψ′}_{t}^{l} ; {η}^{l} )\end{matrix}$$

Here β^{l}∈R^{C}^{^{l}}^{×T} denotes the learnable parameters used to linearly combine the corresponding channels of the task-specific features to construct the shared feature map. To train the network, the entire model is trained end-to-end, ensuring that the gating mechanism learns to select the optimal task-specific and shared features at any given layer based on the training data. During training, sharing of the features can be encouraged or positively biased to occur more frequently by regularizing the gating module G. Sharing features reduces computational costs while also reducing task interference, which can be achieved via a hinge loss over the gating activations for task-specific features:

$${sparsity}_{} = \frac{1}{T \times L} {\sum }_{t = 1}^{T} relu ( {\sum }_{l = 1}^{L} σ ( {α}_{t}^{l} ) - {τ}_{t} )$$

where σ is the sigmoid function and τₜ is a task-specific hinge target. A lower hinge target value encourages more sharing of features while a higher value gives the model the flexibility to select task-specific features albeit at the cost of higher computational costs.

The neural network 400 can determine a loss based on the outputs above and update (e.g., using backpropagation) the parameters of the gating logits for the gating mechanism. The update parameters can include:
(φₜ, αₜ) with respect to ( [symbol] ₜ, [symbol] _{sparsity}),
θ with respect to ( [symbol] ₜ, [symbol] _{T}, [symbol] _{sparsity}),
β with respect to ( [symbol] ₜ, [symbol] _{T}, and
where

$${sparsity}_{} = \frac{1}{T \times L} {\sum }_{t = 1}^{T} relu ( {\sum }_{l = 1}^{L} σ ( {α}_{t}^{l} ) - {τ}_{t} )$$

and [symbol] ₜ are the task-specific losses.

At inference, given the learned gating patterns, the gated multitasking learning model converts to a plain neural network architecture without any gating modules. To be more specific, for a given task, the task-specific weights θₜ corresponding to the channels of φₜ, and if the gate outputs the value 0 for a channel, then that channel can be pruned from the model. Similarly, the shared branch weights η corresponding to the channels of ψ that are chosen not to be used by any of the tasks can be pruned. In other words, the channels that are pruned are removed from the multitasking learning model and inactive. The pruning or removing can simplify the neural network architecture and improve compute efficiency.

For example, FIG. 4 further illustrates that a neural network 400 can include an encoder block at inference 401b. As discussed above, the neural network 400 can be a plain neural network architecture, which refers to herein a neural network without any gating mechanism. Accordingly, the neural network 400 and/or the encoder block at inference 401b is greatly simplified at inference and can efficiently select channels 472a from task-specific features 460 and shared features 464 to use for first task-specific features 470 and channels from task-specific features 462 and shared features 464 to use for second task-specific features 474 based on the dynamically learned gating patterns from the training of the neural network 400 as described above. Accordingly, some channels 472b of the first task-specific features 470 and the second task-specific features 474 are not selected to be used.

The encoder block at inference 401b processes the features of the selected channels 472a with a first task-specific function 476 to generate first task-specific extracted features 490. The encoder block at inference 401b processes the features of the selected channels of the second task-specific feature map 474 using a second task-specific function 478 to generate second task-specific extracted features 492. The encoder block at inference 401b processes features of selected shared channels 479 using a shared function 480 to generate shared extracted features 494. The first task-specific extracted features 490 and shared extracted features 494 can then be concatenated to generate a first extracted output. The second task-specific extracted features 492 and shared extracted features 494 can then be concatenated to generate a second extracted output. The first extracted output and the second extracted output can then be provided to a subsequent layer or decoder as an input.

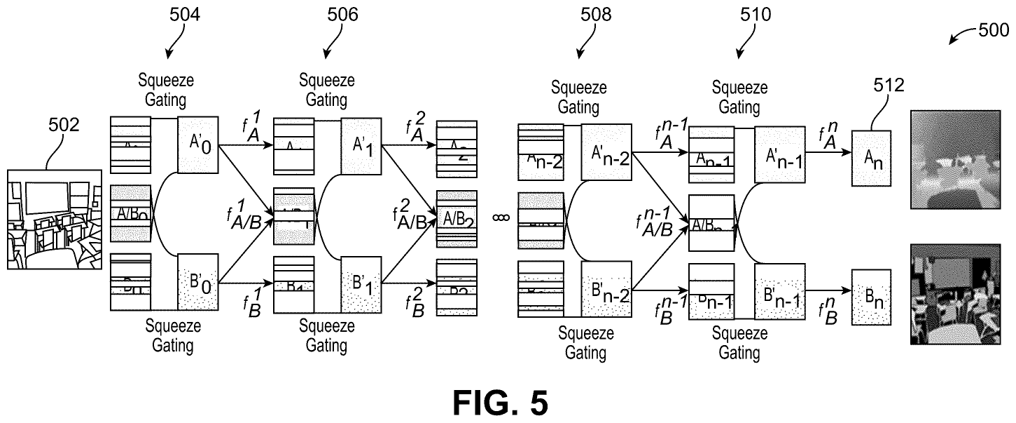

FIG. 5 is a block diagram illustrating an example MTL model 500 having multiple layers or multilayered MTL model 500. As discussed above, outputs from each layer (e.g., a first output feature map, a second output feature map) can be provided to another layer in the neural network. The MTL model 500 is configured to receive an input 502 at a first hidden layer 504 and extract features of the input 502 using a first task specific function (e.g., the task specific function 410 of FIG. 4, the task specific function 430, etc.), a shared function (e.g., the shared function 448 of FIG. 4), and/or a combination thereof. The extracted features (e.g., first extracted features 412, second extracted features 432, shared extracted features 450) can then be combined to generate an output to provide to a subsequent layer (e.g., hidden layers 506, 508, 510, and/or decoders 512 etc.) and/or a decoder head configured to receive the output and generate a higher level output.

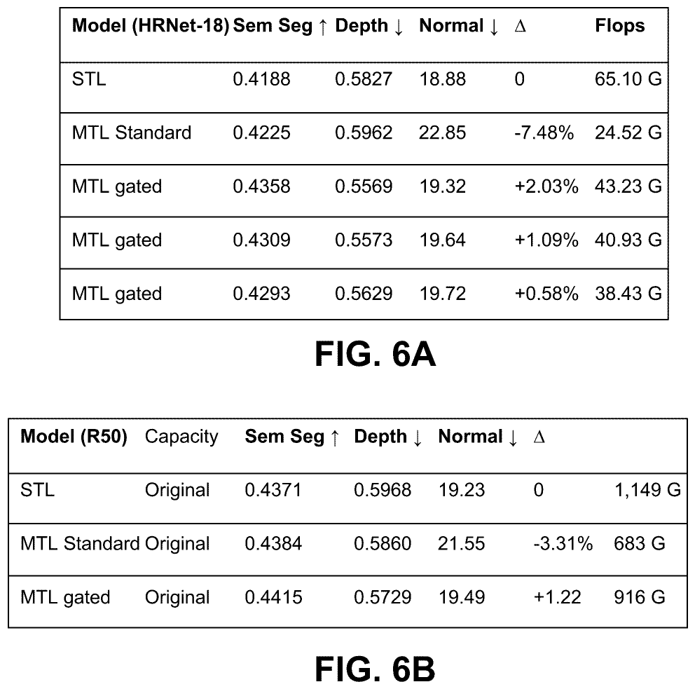

FIG. 6A demonstrates example experimental results comparing performances of a conventional single task learning model, a conventional or standard multitask learning model, and gated multitask learning models. A single task learning model is provided as a baseline to compare performance of conventional MTL models and the presently disclosed MTL models. The models were trained to perform three tasks: semantic segmentation, depth estimation, and surface normal estimation.

While the conventional or standard MTL model is significantly more efficient in terms of compute compared to the single task learning model (e.g., by consuming fewer FLOPS), the standard MTL model demonstrates a substantial decrease in performance for surface normal estimation. Such decrease in performance is unexpected, given that determining the surface normal from the depth estimation or vice versa is a trivial mathematical calculation. Such decrease in performance demonstrates that it is challenging to determine the extent of shareable features across different tasks. For example, it may not be obvious a-priori how shareable the features are between tasks. The standard MTL model also demonstrates that it is possible for one task to overwhelm or negatively affect another task.

The three MTL gated models are configured with different parameters such as sparsity. As demonstrated in FIG. 6A, adjusting the parameters can result in more compute efficient performance and/or more accurate performance. For example, pushing the sparsity term during optimization to encourage sharing features with surface normal estimation causes the MTL model to be more efficient by reducing FLOPS from 43.23 GFLOPS to 38.43 GFLOPS, while slightly performance from the more accurate MTL models. However, even with the lower compute and thus higher efficiency, the MTL model still performs accurately in the three tasks, such that the MTL model is both more compute efficient and more accurate than the single task learning model. Similarly, the lower efficiency MTL model performed a higher number of operations at 43.23 GFLOPS, while demonstrating an improvement in accuracy. Even with the lower efficiency compared to the most compute efficient MTL model, the lower efficiency MTL model is still more efficient than the single task learning model, while also performing more accurately.

FIG. 6B illustrates example experimental results comparing performances of a conventional single task learning model, a conventional or standard multitask learning model, and a gated multitask learning model. The results for these experiments support the same findings above. The single task learning model is more accurate than standard MTL models, but consumes significantly more compute. In contrast, the MTL model trained using the gates of the present disclosure show an increase in both compute efficiency and accuracy compared to the single task learning model.

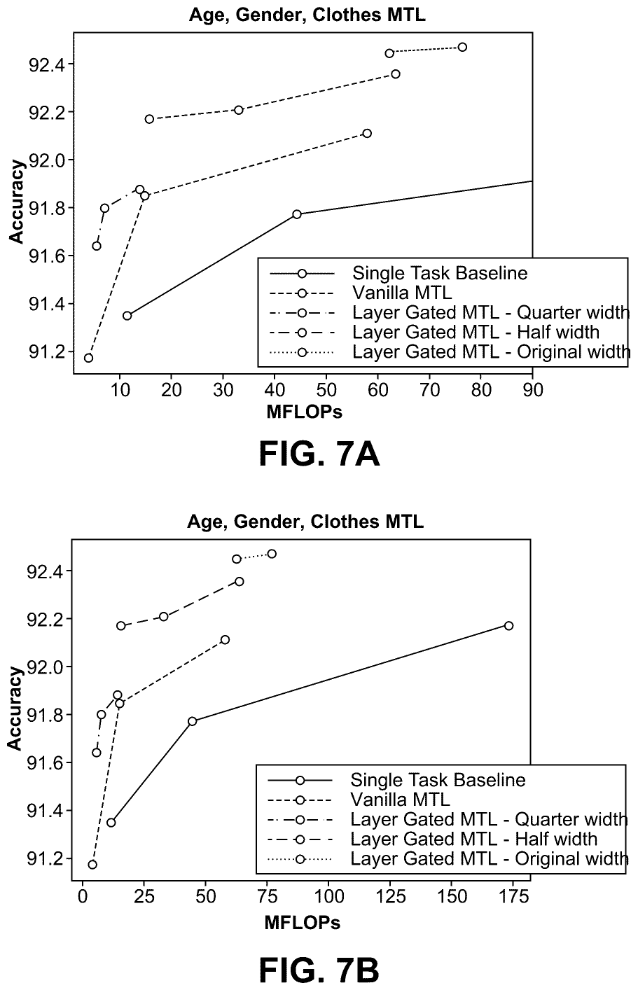

FIGS. 7A and 7B are graphs illustrating the example experimental results of FIG. 6A. As illustrated, the MTL models trained with gates significantly outperform the conventional MTL models and the single task learning models in accuracy per MFLOP. In other words, FIGS. 7A and 7B further support the improvements in both performance and accuracy that the architecture of the gated MTL model provides.

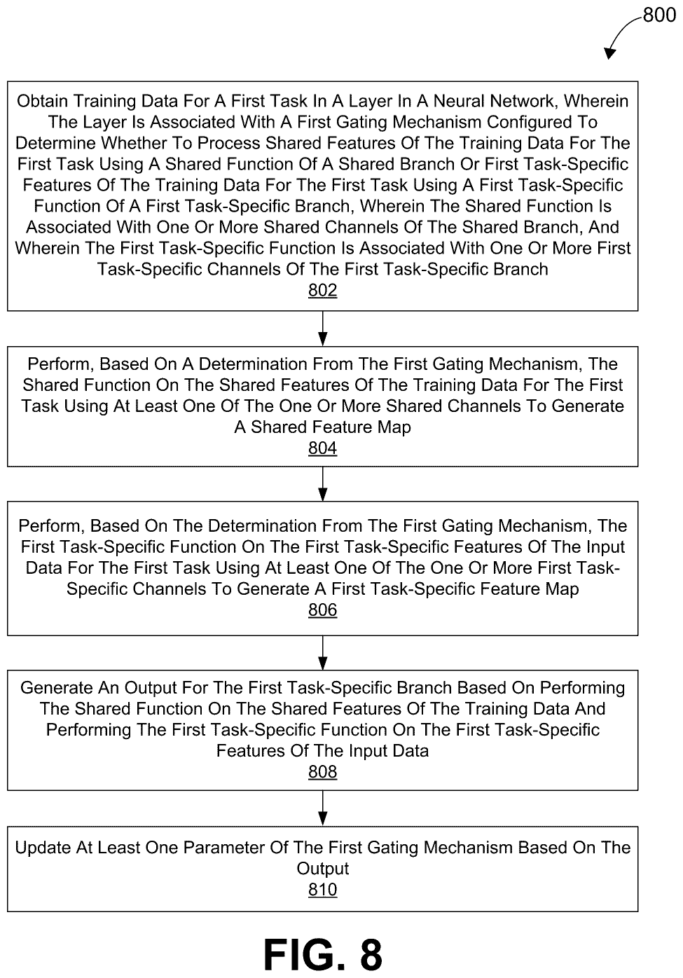

FIG. 8 is a flowchart illustrating an example process 800 for training a neural network to perform at least one task, using one or more of the techniques described herein. The process 800 can be performed by a computing device (or apparatus), or a component of a computing device (e.g., a chipset, one or more processors such as CPU(s), GPU(s), NPU(s), DSP(s), etc.), which may utilize or implementing a machine learning model as described above. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the SOC 100 of FIG. 1, the computing system 1200 of FIG. 12, and/or other computing device or apparatus.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

At block 802, the computing device (or component thereof) can obtain training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch. For instance, the encoder block during training 401a of the neural network 400 of FIG. 4 can obtain training data. In some examples, each shared channel of the one or more shared channels respectively corresponds to each first task-specific channel of the one or more first task-specific channels. In some examples, the first gating mechanism includes a gate for each set of corresponding shared channels and first task-specific channels.

At block 804, the computing device (or component thereof) can perform, based on a determination from the first gating mechanism, the shared function on the shared features of the training data for the first task using at least one of the one or more shared channels to generate a shared feature map. For instance, the shared function 448 can process shared features 444 of selected shared channels 447 to generate the extracted shared features 450 of FIG. 4. In some examples, a number of active first task-specific channels is different from a number of active shared channels. In some examples, the first channel of the one or more shared channels is active and the first channel of the one or more first task-specific channels is inactive. In some examples, the first channel of the one or more shared channels in inactive and the first channel of the one or more first task-specific channels is active.

At block 806, the computing device (or component thereof) can perform, based on the determination from the first gating mechanism, the first task-specific function on the first task-specific features of the input data for the first task using at least one of the one or more first task-specific channels to generate a first task-specific feature map. For instance, the first task-specific function 410 can process first task-specific features 404 of selected channels 406a for the first task-specific features 408 to generate the first task-specific extracted features 412 of FIG. 4.

At block 808, the computing device (or component thereof) can generate an output for the first task-specific branch based on performing the shared function on the shared features of the training data and performing the first task-specific function on the first task-specific features of the input data. For instance, the output can include the first task-specific extracted features 412 and/or the extracted shared features 450 of FIG. 4.

At block 810, the computing device (or component thereof) can update at least one parameter of the first gating mechanism based on the output. For instance, a parameter of the gating mechanism 405 of FIG. 4 can be updated based on the output. In some examples, the at least one parameter of the first gating mechanism includes a plurality of weights.

The computing device (or component thereof) can obtain training data for a second task in the layer of a second task-specific branch in the neural network, wherein the layer is further associated with a second gating mechanism configured to determine whether to process shared features of the training data for the second task using the shared function of the shared branch or second task-specific features of the training data for the second task using a second task-specific function, and wherein the second task-specific function is associated with one or more second task-specific channels of the second task-specific branch. For instance, the training data can include second task-specific features 424 for the second task-specific branch 422 of FIG. 4. In some examples, the first task and the second task can have classifications identifying a type for the task (e.g., image segmentation, surface normal estimation, depth estimation, etc.). In some examples, a classification for the first task is different from a classification for the second task. In some examples, the first task is one of image segmentation, surface normal estimation, depth estimation, or classification.

The computing device (or component thereof) can perform, based on a determination from the second gating mechanism, the shared function on the shared features of the training data for the second task using at least one of the one or more shared channels of the shared feature map to generate a second shared feature map. For instance, the shared function 448 can process shared features 444 of selected shared channels 447 to generate the extracted shared features 450 of FIG. 4. In some examples, a first subset of the one or more shared channels is allocated to a first subset of the training data for the first task and a second subset of the one or more shared channels is allocated to the first subset of the training data for the second task.

The computing device (or component thereof) can perform, based on a determination from the second gating mechanism, the second task-specific function on the second task-specific features of the training data for the second task using at least one of the one or more second task-specific channels to generate a second task-specific feature map. For instance, the second task-specific function 430 can process the second task-specific features of selected channels for the second task-specific feature map 428 to generate the second task-specific extracted features 432 of FIG. 4.

The computing device (or component thereof) can generate a second output for the second task-specific branch based on performing the shared function on the shared features of the training data and performing the second task-specific function on the second task-specific features. For instance, the second output can include the second task-specific extracted features 432 and/or the extracted shared features 450 of FIG. 4.

The computing device (or component thereof) can update at least one parameter of the second gating mechanism based on the second output. For instance, a parameter of the second gating mechanism 425 of FIG. 4 can be updated based on the second output.

The computing device (or component thereof) can determine a loss for first task-specific branch based on the output of the first task-specific branch. For instance, the neural network 400 can determine a loss for the first task-specific branch based on the output of the first task-specific branch 402 of FIG. 4.

The computing device (or component thereof) can update, using backpropagation, the at least one parameter of the first gating mechanism based on the loss. For instance, the neural network 400 can update, using backpropagation, at least one parameter of the first gating mechanism 405 of FIG. 4 based on the loss.

The computing device (or component thereof) can determine a second loss for the second task-specific branch based on the output of the second task-specific branch. For instance, the neural network 400 can determine a loss for the second task-specific branch based on the second output of the second task-specific branch 422 of FIG. 4.

The computing device (or component thereof) can update, using backpropagation, the at least one parameter of the second gating mechanism based on the loss. For instance, the neural network 400 can update, using backpropagation, at least one parameter of the second gating mechanism 425 of FIG. 4 based on the loss.

The computing device (or component thereof) can, based on the updated first gating mechanism, select between at least one channel of the one or more task-specific channels and at least one corresponding channel of the one or more shared channels. For instance, the gating mechanism 405 of FIG. 4 can select, after updating the parameters for the first gating mechanism 405, at least one channel of the one or more first task-specific channels 406a, 406b and at least one corresponding channel of the one or more shared channels for shared features 444.

The computing device (or component thereof) can prune unselected channels based on the selection by the updated first gating mechanism. For instance, the neural network 400 can prune or otherwise remove unselected channels 406b based on the selection by the updated first gating mechanism.

The computing device (or component thereof) can remove the first gating mechanism from the layer. For instance, the neural network 400 can remove the first gating mechanism 405 of FIG. 4 from the layer.

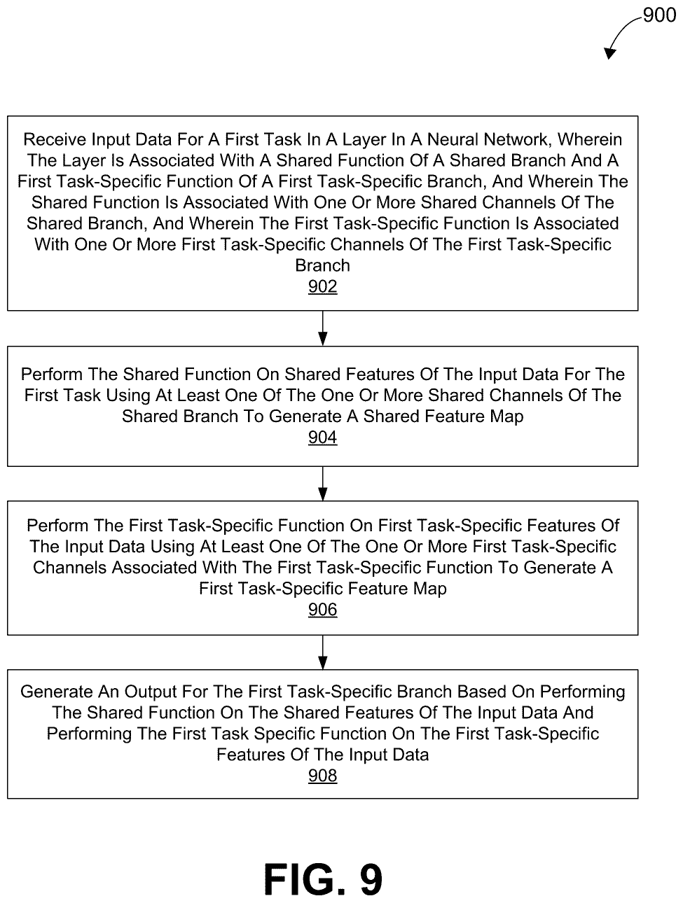

FIG. 9 illustrates an example process 900 for performing at least one task using a neural network. The process 900 can be performed by a computing device (or apparatus), or a component of a computing device (e.g., a chipset, one or more processors such as CPU(s), GPU(s), NPU(s), DSP(s), etc.), which may utilize or implementing a machine learning model (e.g., the neural network 400 of FIG. 4, etc.). The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the SOC 100 of FIG. 1, the computing system 1200 of FIG. 12, and/or other computing device or apparatus.

Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

At block 902, the computing device (or component thereof) can receive input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch. For instance, the encoder block at inference 401b of the neural network 400 of FIG. 4 can receive input data for the first task.

At block 904, the computing device (or component thereof) can perform the shared function on shared features of the input data for the first task using at least one of the one or more shared channels of the shared branch to generate a shared feature map. For instance, the shared function 480 can be performed on the shared features of selected channels 479 to generate the extracted shared features 494 of FIG. 4.

At block 906, the computing device (or component thereof) can perform the first task-specific function on first task-specific features of the input data using at least one of the one or more first task-specific channels associated with the first task-specific function to generate a first task-specific feature map. For instance, the first task-specific function 476 can be performed on the first task-specific features of selected channels 472a to generate the first task-specific extracted features 490 of FIG. 4.

At block 908, the computing device (or component thereof) can generate an output for the first task-specific branch based on performing the shared function on the shared features of the input data and performing the first task specific function on the first task-specific features of the input data. For instance, the encoder block at inference 401b can generate an output for the first task-specific branch 402 based on the extracted shared features 494 and the first task-specific extracted features 490 of FIG. 4.

The computing device (or component thereof) can receive input data for a second task in the layer in the neural network, wherein the layer is further associated with a second task-specific function, and wherein the second task-specific function is associated with one or more second task-specific channels. For instance, the encoder block at inference 401b of the neural network 400 of FIG. 4 can receive input data for the second task.

The computing device (or component thereof) can perform the shared function on shared features of the input data for the second task using at least one of the one or more shared channels of the shared feature map to generate a second shared feature map. For instance, the shared function 480 can be performed on the shared features of selected channels 479 to generate the extracted shared features 494 of FIG. 4.

The computing device (or component thereof) can perform the second task-specific function on second task-specific features of the input data for the second task using at least one of the one or more second task-specialized channels to generate a second task-specific feature map. For instance, the first task-specific function 476 can be performed on the second task-specific features 474 of selected channels to generate the second task-specific extracted features 492 of FIG. 4.

The computing device (or component thereof) can generate an output for the first task-specific branch based on performing the shared function on the shared features of the input data and performing the first task-specific function on the first task-specific features of the input data. For instance, the encoder block at inference 401b can generate a second output for the second task-specific branch 422 based on the extracted shared features 494 and the second task-specific extracted features 492 of FIG. 4.

The computing device (or component thereof) can receive the output in a subsequent layer of the neural network, wherein the subsequent layer includes a third task-specific function of the first task-specific branch and a second shared function of the shared branch, and wherein the third task-specific function includes a plurality of third task-specific channels, and wherein the second shared function includes a plurality of shared channels. For example, the output can be received by the subsequent layer(s) 506, 508, 510 of FIG. 5.

The computing device (or component thereof) can perform the third task-specific function on third task-specific features of the output using at least one of the plurality of third task-specific channels to generate a first subsequent feature map. For instance, the encoder block at inference 401b as described in FIG. 4 for the hidden layer 506 of FIG. 5 can perform the third task-specific function on third task-specific features of the output.

The computing device (or component thereof) can perform the second shared function on shared features of the output using at least one of the plurality of shared channels to generate a second subsequent feature map. For instance, the encoder block at inference 401b as described in FIG. 4 for the hidden layer 506 of FIG. 5 can perform the second shared function on shared features of the output.

The computing device (or component thereof) can generate a subsequent output for the third task-specific branch based on performing the second shared function on the shared features of the output and performing the third task-specific function on the third task-specific features of the output. For instance, the encoder block at inference 401b as described in FIG. 4 for the hidden layer 506 of FIG. 5 can generate a subsequent output for the third task-specific branch.

As noted above, the methods and processes described herein (e.g., processes 800, 900 and/or any other process described herein) may be performed by a computing device or apparatus utilizing or implementing a machine learning model (e.g., the neural network 400 of FIG. 4, the multilayered MTL model 500 of FIG. 5, etc.). In some examples, the processes 800, 900 can be performed by the electronic device 100 of FIG. 1. In another example, the processes 800, 900 can be performed by the computing system having the computing device architecture of the computing system 1200 shown in FIG. 12. For instance, a computing device with the computing device architecture of the computing system 1200 shown in FIG. 12 can implement the operations of FIGS. 8 and 9 and/or the components and/or operations described herein with respect to any of FIGS. 3-9.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the processes 800, 900 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 800, 900 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 800, 900 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

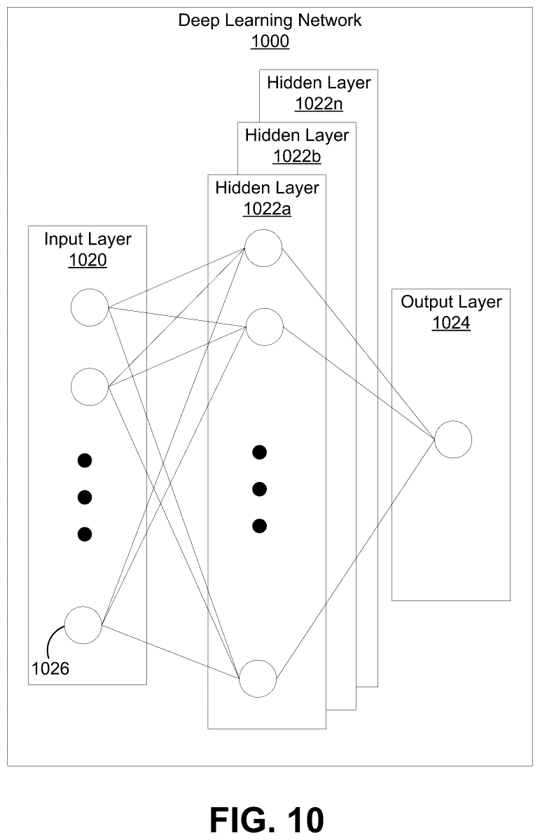

FIG. 10 is an illustrative example of a deep learning neural network 1000 that can be used by the machine learning model or the neural network 400 of FIG. 4, the multilayered MTL model 500 of FIG. 5, etc.). An input layer 1020 includes input data. In some examples, the input layer 1020 can include data representing the pixels of an input video frame. The neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network 1000 further includes an output layer 1024 that provides an output resulting from the processing performed by the hidden layers 1022a, 1022b, through 1022n. In some examples, the output layer 1024 can provide a classification for an object in an input video frame. The classification can include a class identifying the type of object (e.g., a person, a dog, a cat, or other object).

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the hidden layers 1022a, 1022b, through 1022n can transform the information of each input node by applying activation functions to the information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1024, at which an output is provided. In some cases, while nodes (e.g., node 1026) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. Once the neural network 1000 is trained, the neural network 1000 can be referred to as a trained neural network. The trained neural network 1000 can be used to classify one or more objects. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1024. In an example in which the neural network 1000 is used to identify objects in images, the neural network 1000 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0].

In some cases, the neural network 1000 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1000 is trained well enough so that the weights of the layers are accurately tuned.

For the example of identifying objects in images, the forward pass can include passing a training image through the neural network 1000. The weights are initially randomized before the neural network 1000 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 1000, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1000 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = Σ \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1000 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 1000 can include any suitable deep network. As described previously, an example of a neural network 1000 includes a convolutional neural network (CNN), which includes an input layer and an output layer, with multiple hidden layers between the input and out layers. An example of a CNN is described below with respect to FIG. 11. The hidden layers of a CNN include a series of convolutional, nonlinear, pooling (for downsampling), and fully connected layers. The neural network 1000 can include any other deep network other than a CNN, such as an autoencoder, a deep belief nets (DBNs), a Recurrent Neural Networks (RNNs), among others.

FIG. 11 is an illustrative example of a convolutional neural network 1100 (CNN 1100). The input layer 1120 of the CNN 1100 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1122a, an optional non-linear activation layer, a pooling hidden layer 1122b, and fully connected hidden layers 1122c to get an output at the output layer 1124. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 is the convolutional hidden layer 1122a. The convolutional hidden layer 1122a analyzes the image data of the input layer 1120. Each node of the convolutional hidden layer 1122a is connected to a region of nodes (pixels) of the input image called a receptive field. The convolutional hidden layer 1122a can be considered as one or more filters (each filter corresponding to a different activation or feature map), with each convolutional iteration of a filter being a node or neuron of the convolutional hidden layer 1122a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 1122a. Each connection between a node and a receptive field for that node learns a weight and, in some cases, an overall bias such that each node learns to analyze its particular local receptive field in the input image. Each node of the hidden layer 1122a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1122a is due to each node of the convolutional layer being applied to its corresponding receptive field. For example, a filter of the convolutional hidden layer 1122a can begin in the top-left corner of the input image array and can convolve around the input image. As noted above, each convolutional iteration of the filter can be considered a node or neuron of the convolutional hidden layer 1122a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1122a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1122a.

The mapping from the input layer to the convolutional hidden layer 1122a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1122a can include several activation maps in order to identify multiple features in an image. The example shown in FIG. 11 includes three activation maps. Using three activation maps, the convolutional hidden layer 1122a can detect three different kinds of features, with each feature being detectable across the entire image.

In some examples, a non-linear hidden layer can be applied after the convolutional hidden layer 1122a. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 1100 without affecting the receptive fields of the convolutional hidden layer 1122a.

The pooling hidden layer 1122b can be applied after the convolutional hidden layer 1122a (and after the non-linear hidden layer when used). The pooling hidden layer 1122b is used to simplify the information in the output from the convolutional hidden layer 1122a. For example, the pooling hidden layer 1122b can take each activation map output from the convolutional hidden layer 1122a and generates a condensed activation map (or feature map) using a pooling function. Max-pooling is an example of a function performed by a pooling hidden layer. Other forms of pooling functions be used by the pooling hidden layer 1122b, such as average pooling, L2-norm pooling, or other suitable pooling functions. A pooling function (e.g., a max-pooling filter, an L2-norm filter, or other suitable pooling filter) is applied to each activation map included in the convolutional hidden layer 1122a. In the example shown in FIG. 11, three pooling filters are used for the three activation maps in the convolutional hidden layer 1122a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1122a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1122a having a dimension of 24×24 nodes, the output from the pooling hidden layer 1122b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image. The pooling function can then discards the exact positional information. Such pooling operations can be performed without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1122b to every one of the output nodes in the output layer 1124. Using the example above, the input layer includes 28×28 nodes encoding the pixel intensities of the input image, the convolutional hidden layer 1122a includes 3×24×24 hidden feature nodes based on application of a 5×5 local receptive field (for the filters) to three activation maps, and the pooling layer 1122b includes a layer of 3×12×12 hidden feature nodes based on application of max-pooling filter to 2×2 regions across each of the three feature maps. Extending this example, the output layer 1124 can include ten output nodes. In such an example, every node of the 3×12×12 pooling hidden layer 1122b is connected to every node of the output layer 1124.

The fully connected layer 1122c can obtain the output of the previous pooling layer 1122b (which should represent the activation maps of high-level features) and determines the features that most correlate to a particular class. For example, the fully connected layer 1122c layer can determine the high-level features that most strongly correlate to a particular class, and can include weights (nodes) for the high-level features. A product can be computed between the weights of the fully connected layer 1122c and the pooling hidden layer 1122b to obtain probabilities for the different classes. For example, if the CNN 1100 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1124 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 12 is a diagram illustrating an example of a system for implementing certain aspects of the present disclosure. In particular, FIG. 12 illustrates an example of computing system 1200, which can be for example any computing device making up a computing system, a camera system, or any component thereof in which the components of the system are in communication with each other using connection 1202. Connection 1202 can be a physical connection via a bus, or a direct connection into processor 1204, such as in a chipset architecture. Connection 1202 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (CPU or processor) 1204 and connection 1202 that couples various system components including system memory 1208, such as read-only memory (ROM) 1210 and random access memory (RAM) 1212 to processor 1204. Computing system 1200 can include a cache of high-speed memory 1206 connected directly with, in close proximity to, or integrated as part of processor 1204.

Processor 1204 can include any general purpose processor and a hardware service or software service, such as services 1216, 1218, and 1220 stored in storage device 1214, configured to control processor 1204 as well as a special-purpose processor where software instructions are incorporated into the actual processor design. Processor 1204 may essentially be a completely self-contained computing system, containing multiple cores or processors, a bus, memory controller, cache, etc. A multi-core processor may be symmetric or asymmetric.

To enable user interaction, computing system 1200 includes an input device 1226, which can represent any number of input mechanisms, such as a microphone for speech, a touch-sensitive screen for gesture or graphical input, keyboard, mouse, motion input, speech, etc. Computing system 1200 can also include output device 1222, which can be one or more of a number of output mechanisms known to those of skill in the art. In some instances, multimodal systems can enable a user to provide multiple types of input/output to communicate with computing system 1200. Computing system 1200 can include communication interface 1224, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1502.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications communication interface 1224 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1214 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1214 can include software services, servers, services, etc., that when the code that defines such software is executed by the processor 1204, it causes the system to perform a function. In some embodiments, a hardware service that performs a particular function can include the software component stored in a computer-readable medium in connection with the necessary hardware components, such as processor 1204, connection 1202, output device 1222, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for training a neural network to perform at least one task, comprising: at least one memory; and at least one processor coupled to the at least one memory, the at least one processor configured to: obtain training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch; perform, based on a determination from the first gating mechanism, the shared function on the shared features of the training data for the first task using at least one of the one or more shared channels to generate a shared feature map; perform, based on the determination from the first gating mechanism, the first task-specific function on the first task-specific features of the training data for the first task using at least one of the one or more first task-specific channels to generate a first task-specific feature map; generate an output for the first task-specific branch based on performing the shared function on the shared features of the training data and performing the first task-specific function on the first task-specific features of the training data; and update at least one parameter of the first gating mechanism based on the output.

Aspect 2. The apparatus of Aspect 1, wherein each shared channel of the one or more shared channels respectively corresponds to each first task-specific channel of the one or more first task-specific channels.

Aspect 3. The apparatus of any of Aspect 1 to 2, wherein the first gating mechanism includes a gate for each set of corresponding shared channels and first task-specific channels.

Aspect 4. The apparatus of any of Aspect 1 to 3, wherein the at least one parameter of the first gating mechanism includes a plurality of weights.

Aspect 5. The apparatus of Aspect 4, wherein the at least one processor is further configured to: process the at least one parameter using a sigmoid function to generate a value; compare the value to a threshold value to provide a binary selection; and select, based on the binary selection, between the first task-specific function and the shared function.

Aspect 6. The apparatus of any of Aspect 1 to 5, wherein the at least one processor is further configured to: determine a loss for first task-specific branch based on the output of the first task-specific branch; and update, using backpropagation, the at least one parameter of the first gating mechanism based on the loss.

Aspect 7. The apparatus of any of Aspect 1 to 6, wherein the at least one processor is further configured to: obtain training data for a second task in the layer of a second task-specific branch in the neural network, wherein the layer is further associated with a second gating mechanism configured to determine whether to process shared features of the training data for the second task using the shared function of the shared branch or second task-specific features of the training data for the second task using a second task-specific function, and wherein the second task-specific function is associated with one or more second task-specific channels of the second task-specific branch; perform, based on a determination from the second gating mechanism, the shared function on the shared features of the training data for the second task using at least one of the one or more shared channels of the shared feature map to generate a second shared feature map; perform, based on a determination from the second gating mechanism, the second task-specific function on the second task-specific features of the training data for the second task using at least one of the one or more second task-specific channels to generate a second task-specific feature map; generate a second output for the second task-specific branch based on performing the shared function on the shared features of the training data and performing the second task-specific function on the second task-specific features; and update at least one parameter of the second gating mechanism based on the second output.

Aspect 8. The apparatus of Aspect 7, wherein the at least one processor is further configured to: determine a second loss for the second task-specific branch based on the output of the second task-specific branch; and update, using backpropagation, the at least one parameter of the second gating mechanism based on the second loss.

Aspect 9. The apparatus of any of Aspect 7 to 8, wherein a first subset of the one or more shared channels is allocated to a first subset of the training data for the first task and a second subset of the one or more shared channels is allocated to the first subset of the training data for the second task.

Aspect 10. The apparatus of any of Aspect 7 to 9, wherein a classification of the first task is different from a classification of the second task.

Aspect 11. The apparatus of any of Aspect 1 to 10, wherein the at least one processor is further configured to: based on the first gating mechanism, select between at least one channel of the one or more first task-specific channels and at least one corresponding channel of the one or more shared channels; and prune unselected channels based on the selection by the first gating mechanism.

Aspect 12. The apparatus of any of Aspect 1 to 11, wherein a number of active first task-specific channels is different from a number of active shared channels.

Aspect 13. The apparatus of any of Aspect 1 to 12, wherein a first channel of the one or more shared channels corresponds to a first channel of the one or more first task-specific channels.

Aspect 14. The apparatus of Aspect 13, wherein the first channel of the one or more shared channels is active and the first channel of the one or more first task-specific channels is inactive.

Aspect 15. The apparatus of any of Aspect 13 to 14, wherein the first channel of the one or more shared channels in inactive and the first channel of the one or more first task-specific channels is active.

Aspect 16. The apparatus of any of Aspect 1 to 15, wherein the first task is one of image segmentation, surface normal estimation, depth estimation, or classification.

Aspect 17. A processor-implemented method for training a neural network to perform at least one task, comprising: obtaining training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch; performing, based on a determination from the first gating mechanism, the shared function on the shared features of the training data for the first task using at least one of the one or more shared channels to generate a shared feature map; performing, based on the determination from the first gating mechanism, the first task-specific function on the first task-specific features of the training data for the first task using at least one of the one or more first task-specific channels to generate a first task-specific feature map; generating an output for the first task-specific branch based on performing the shared function on the shared features of the training data and performing the first task-specific function on the first task-specific features of the training data; and updating at least one parameter of the first gating mechanism based on the output.

Aspect 18. The processor-implemented method of Aspect 17, wherein each shared channel of the one or more shared channels respectively corresponds to each first task-specific channel of the one or more first task-specific channels.

Aspect 19. The processor-implemented method of any of Aspect 17 to 18, wherein the first gating mechanism includes a gate for each set of corresponding shared channels and first task-specific channels.

Aspect 20. The processor-implemented method of any of Aspect 17 to 19, wherein the at least one parameter of the first gating mechanism includes a plurality of weights.

Aspect 21. The processor-implemented method of Aspect 20, further comprising: processing the at least one parameter using a sigmoid function to generate a value; comparing the value to a threshold value to provide a binary selection; and selecting, based on the binary selection, between the first task-specific function and the shared function.

Aspect 22. The processor-implemented method of any of Aspect 17 to 21, further comprising: determining a loss for first task-specific branch based on the output of the first task-specific branch; and updating, using backpropagation, the at least one parameter of the first gating mechanism based on the loss.

Aspect 23. The processor-implemented method of any of Aspect 17 to 22, further comprising: obtaining training data for a second task in the layer of a second task-specific branch in the neural network, wherein the layer is further associated with a second gating mechanism configured to determine whether to process shared features of the training data for the second task using the shared function of the shared branch or second task-specific features of the training data for the second task using a second task-specific function, and wherein the second task-specific function is associated with one or more second task-specific channels of the second task-specific branch; performing, based on a determination from the second gating mechanism, the shared function on the shared features of the training data for the second task using at least one of the one or more shared channels of the shared feature map to generate a second shared feature map; performing, based on a determination from the second gating mechanism, the second task-specific function on the second task-specific features of the training data for the second task using at least one of the one or more second task-specific channels to generate a second task-specific feature map; generating a second output for the second task-specific branch based on performing the shared function on the shared features of the training data and performing the second task-specific function on the second task-specific features; and updating at least one parameter of the second gating mechanism based on the second output.

Aspect 24. The processor-implemented method of Aspect 23, further comprising: determining a second loss for the second task-specific branch based on the output of the second task-specific branch; and updating, using backpropagation, the at least one parameter of the second gating mechanism based on the second loss.

Aspect 25. The processor-implemented method of any of Aspect 23 to 24, wherein a first subset of the one or more shared channels is allocated to a first subset of the training data for the first task and a second subset of the one or more shared channels is allocated to the first subset of the training data for the second task.

Aspect 26. The processor-implemented method of any of Aspect 23 to 25, wherein a classification of the first task is different from a classification of the second task.

Aspect 27. The processor-implemented method of any of Aspect 17 to 26, further comprising: based on the first gating mechanism, selecting between at least one channel of the one or more first task-specific channels and at least one corresponding channel of the one or more shared channels; and pruning unselected channels based on the selection by the first gating mechanism.

Aspect 28. The processor-implemented method of any of Aspect 17 to 27, wherein a number of active first task-specific channels is different from a number of active shared channels.

Aspect 29. The processor-implemented method of any of Aspect 17 to 28, wherein a first channel of the one or more shared channels corresponds to a first channel of the one or more first task-specific channels.

Aspect 30. The processor-implemented method of Aspect 29, wherein the first channel of the one or more shared channels is active and the first channel of the one or more first task-specific channels is inactive.

Aspect 31. The processor-implemented method of any of Aspect 29 to 30, wherein the first channel of the one or more shared channels in inactive and the first channel of the one or more first task-specific channels is active.

Aspect 32. The processor-implemented method of any of Aspect 17 to 31, wherein the first task is one of image segmentation, surface normal estimation, depth estimation, or classification.

Aspect 33. A non-transitory computer-readable storage medium comprising instructions stored thereon which, when executed by at least one processor, causes the at least one processor to perform operations according to any one of Aspects 1 to 16.

Aspect 34. A non-transitory computer-readable storage medium comprising instructions stored thereon which, when executed by at least one processor, causes the at least one processor to perform operations according to any one of Aspects 17 to 32.

Aspect 35. An apparatus for training a neural network to perform at least one task, comprising one or more means for performing operations according to any one of Aspects 1 to 16.

Aspect 36. An apparatus for training a neural network to perform at least one task, comprising one or more means for performing operations according to any one of Aspects 17 to 32.

Aspect 37. An apparatus for performing at least one task, comprising: at least one memory; and at least one processor coupled to the at least one memory, the at least one processor configured to: receive input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch; perform the shared function on shared features of the input data for the first task using at least one of the one or more shared channels of the shared branch to generate a shared feature map; perform the first task-specific function on first task-specific features of the input data using at least one of the one or more first task-specific channels associated with the first task-specific function to generate a first task-specific feature map; and generate an output for the first task-specific branch based on performing the shared function on the shared features of the input data and performing the first task-specific function on the first task-specific features of the input data.

Aspect 38. The apparatus of Aspect 37, wherein the at least one processor is further configured to: receive input data for a second task in the layer in the neural network, wherein the layer is further associated with a second task-specific function, and wherein the second task-specific function is associated with one or more second task-specific channels; perform the shared function on shared features of the input data for the second task using at least one of the one or more shared channels of the shared feature map to generate a second shared feature map; perform the second task-specific function on second task-specific features of the input data for the second task using at least one of the one or more second task-specific channels to generate a second task-specific feature map; and generate an output for the first task-specific branch based on performing the shared function on the shared features of the input data and performing the first task-specific function on the first task-specific features of the input data.

Aspect 39. The apparatus of any of Aspect 37 to 38, wherein the at least one processor is further configured to: receive the output in a subsequent layer of the neural network, wherein the subsequent layer includes a third task-specific function of the first task-specific branch and a second shared function of the shared branch, and wherein the third task-specific function includes a plurality of third task-specific channels, and wherein the second shared function includes a plurality of shared channels; perform the third task-specific function on third task-specific features of the output using at least one of the plurality of third task-specific channels to generate a first subsequent feature map; perform the second shared function on shared features of the output using at least one of the plurality of shared channels to generate a second subsequent feature map; and generate a subsequent output for the first task-specific branch based on performing the second shared function on the shared features of the output and performing the third task-specific function on the third task-specific features of the output.

Aspect 40. A processor-implemented method for performing at least one task, comprising: receiving input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch; performing the shared function on shared features of the input data for the first task using at least one of the one or more shared channels of the shared branch to generate a shared feature map; performing the first task-specific function on first task-specific features of the input data using at least one of the one or more first task-specific channels associated with the first task-specific function to generate a first task-specific feature map; and generating an output for the first task-specific branch based on performing the shared function on the shared features of the input data and performing the first task-specific function on the first task-specific features of the input data.

Aspect 41. The processor-implemented method of Aspect 40, comprising: receiving input data for a second task in the layer in the neural network, wherein the layer is further associated with a second task-specific function, and wherein the second task-specific function is associated with one or more second task-specific channels; performing the shared function on shared features of the input data for the second task using at least one of the one or more shared channels of the shared feature map to generate a second shared feature map; performing the second task-specific function on second task-specific features of the input data for the second task using at least one of the one or more second task-specific channels to generate a second task-specific feature map; and generating an output for the first task-specific branch based on performing the shared function on the shared features of the input data and performing the first task-specific function on the first task-specific features of the input data.

Aspect 42. The processor-implemented method of any of Aspect 40 to 41, comprising: receiving the output in a subsequent layer of the neural network, wherein the subsequent layer includes a third task-specific function of the first task-specific branch and a second shared function of the shared branch, and wherein the third task-specific function includes a plurality of third task-specific channels, and wherein the second shared function includes a plurality of shared channels; performing the third task-specific function on third task-specific features of the output using at least one of the plurality of third task-specific channels to generate a first subsequent feature map; performing the second shared function on shared features of the output using at least one of the plurality of shared channels to generate a second subsequent feature map; and generating a subsequent output for the first task-specific branch based on performing the second shared function on the shared features of the output and performing the third task-specific function on the third task-specific features of the output.

Aspect 43. An apparatus for performing at least one task, comprising one or more means for performing operations according to any one of Aspects 37 to 39.

Aspect 44. An apparatus for performing at least one task, comprising one or more means for performing operations according to any one of Aspects 40 to 42.

What is claimed is:

1. An apparatus for training a neural network to perform at least one task, comprising:
at least one memory; and
at least one processor coupled to the at least one memory, the at least one processor configured to:
obtain training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch;
perform, based on a determination from the first gating mechanism, the shared function on the shared features of the training data for the first task using at least one of the one or more shared channels to generate a shared feature map;
perform, based on the determination from the first gating mechanism, the first task-specific function on the first task-specific features of the training data for the first task using at least one of the one or more first task-specific channels to generate a first task-specific feature map;
generate an output for the first task-specific branch based on performing the shared function on the shared features of the training data and performing the first task-specific function on the first task-specific features of the training data; and
update at least one parameter of the first gating mechanism based on the output.

2. The apparatus of claim 1, wherein each shared channel of the one or more shared channels respectively corresponds to each first task-specific channel of the one or more first task-specific channels.

3. The apparatus of claim 1, wherein the first gating mechanism includes a gate for each set of corresponding shared channels and first task-specific channels.

4. The apparatus of claim 1, wherein the at least one parameter of the first gating mechanism includes a plurality of weights.

5. The apparatus of claim 4, wherein the at least one processor is further configured to:
process the at least one parameter using a sigmoid function to generate a value;
compare the value to a threshold value to provide a binary selection; and
select, based on the binary selection, between the first task-specific function and the shared function.

6. The apparatus of claim 1, wherein the at least one processor is further configured to:
determine a loss for first task-specific branch based on the output of the first task-specific branch; and
update, using backpropagation, the at least one parameter of the first gating mechanism based on the loss.

7. The apparatus of claim 1, wherein the at least one processor is further configured to:
obtain training data for a second task in the layer of a second task-specific branch in the neural network, wherein the layer is further associated with a second gating mechanism configured to determine whether to process shared features of the training data for the second task using the shared function of the shared branch or second task-specific features of the training data for the second task using a second task-specific function, and wherein the second task-specific function is associated with one or more second task-specific channels of the second task-specific branch;
perform, based on a determination from the second gating mechanism, the shared function on the shared features of the training data for the second task using at least one of the one or more shared channels of the shared feature map to generate a second shared feature map;
perform, based on a determination from the second gating mechanism, the second task-specific function on the second task-specific features of the training data for the second task using at least one of the one or more second task-specific channels to generate a second task-specific feature map;
generate a second output for the second task-specific branch based on performing the shared function on the shared features of the training data and performing the second task-specific function on the second task-specific features; and
update at least one parameter of the second gating mechanism based on the second output.

8. The apparatus of claim 7, wherein the at least one processor is further configured to:
determine a second loss for the second task-specific branch based on the output of the second task-specific branch; and
update, using backpropagation, the at least one parameter of the second gating mechanism based on the second loss.

9. The apparatus of claim 7, wherein a first subset of the one or more shared channels is allocated to a first subset of the training data for the first task and a second subset of the one or more shared channels is allocated to the first subset of the training data for the second task.

10. The apparatus of claim 7, wherein a classification of the first task is different from a classification of the second task.

11. The apparatus of claim 1, wherein the at least one processor is further configured to:
based on the first gating mechanism, select between at least one channel of the one or more first task-specific channels and at least one corresponding channel of the one or more shared channels; and
prune unselected channels based on the selection by the first gating mechanism.

12. The apparatus of claim 1, wherein a number of active first task-specific channels is different from a number of active shared channels.

13. The apparatus of claim 1, wherein a first channel of the one or more shared channels corresponds to a first channel of the one or more first task-specific channels.

14. The apparatus of claim 13, wherein the first channel of the one or more shared channels is active and the first channel of the one or more first task-specific channels is inactive.

15. The apparatus of claim 13, wherein the first channel of the one or more shared channels in inactive and the first channel of the one or more first task-specific channels is active.

16. The apparatus of claim 1, wherein the first task is one of image segmentation, surface normal estimation, depth estimation, or classification.

17. An apparatus for performing at least one task, comprising:
at least one memory; and
at least one processor coupled to the at least one memory, the at least one processor configured to:
receive input data for a first task in a layer in a neural network, wherein the layer is associated with a shared function of a shared branch and a first task-specific function of a first task-specific branch, and wherein the shared function is associated with one or more shared channels of the shared branch, and wherein the first task-specific function is associated with one or more first task-specific channels of the first task-specific branch;
perform the shared function on shared features of the input data for the first task using at least one of the one or more shared channels of the shared branch to generate a shared feature map;
perform the first task-specific function on first task-specific features of the input data using at least one of the one or more first task-specific channels associated with the first task-specific function to generate a first task-specific feature map; and
generate an output for the first task-specific branch based on performing the shared function on the shared features of the input data and performing the first task-specific function on the first task-specific features of the input data.

18. The apparatus of claim 17, wherein the at least one processor is further configured to:
receive input data for a second task in the layer in the neural network, wherein the layer is further associated with a second task-specific function, and wherein the second task-specific function is associated with one or more second task-specific channels;
perform the shared function on shared features of the input data for the second task using at least one of the one or more shared channels of the shared feature map to generate a second shared feature map;
perform the second task-specific function on second task-specific features of the input data for the second task using at least one of the one or more second task-specific channels to generate a second task-specific feature map; and
generate an output for the first task-specific branch based on performing the shared function on the shared features of the input data and performing the first task-specific function on the first task-specific features of the input data.

19. The apparatus of claim 17, wherein the at least one processor is further configured to:
receive the output in a subsequent layer of the neural network, wherein the subsequent layer includes a third task-specific function of the first task-specific branch and a second shared function of the shared branch, and wherein the third task-specific function includes a plurality of third task-specific channels, and wherein the second shared function includes a plurality of shared channels;
perform the third task-specific function on third task-specific features of the output using at least one of the plurality of third task-specific channels to generate a first subsequent feature map;
perform the second shared function on shared features of the output using at least one of the plurality of shared channels to generate a second subsequent feature map; and
generate a subsequent output for the first task-specific branch based on performing the second shared function on the shared features of the output and performing the third task-specific function on the third task-specific features of the output.

20. A processor-implemented method for training a neural network to perform at least one task, comprising:
obtain training data for a first task in a layer in a neural network, wherein the layer is associated with a first gating mechanism configured to determine whether to process shared features of the training data for the first task using a shared function of a shared branch or first task-specific features of the training data for the first task using a first task-specific function of a first task-specific branch, wherein the shared function is associated with one or more shared channels of the shared branch, and wherein the first task-specific function is associated with one or more first task-specific channels of the first task-specific branch;
perform, based on a determination from the first gating mechanism, the shared function on the shared features of the training data for the first task using at least one of the one or more shared channels to generate a shared feature map;
perform, based on the determination from the first gating mechanism, the first task-specific function on the first task-specific features of the training data for the first task using at least one of the one or more first task-specific channels to generate a first task-specific feature map;
generate an output for the first task-specific branch based on performing the shared function on the shared features of the training data and performing the first task-specific function on the first task-specific features of the training data; and
update at least one parameter of the first gating mechanism based on the output.

21. The processor-implemented method of claim 20, wherein each shared channel of the one or more shared channels respectively corresponds to each first task-specific channel of the one or more first task-specific channels.

22. The processor-implemented method of claim 20, wherein the first gating mechanism includes a gate for each set of corresponding shared channels and first task-specific channels.

23. The processor-implemented method of claim 20, wherein the at least one parameter of the first gating mechanism includes a plurality of weights.

24. The processor-implemented method of claim 23, further comprising:
processing the at least one parameter using a sigmoid function to generate a value;
comparing the value to a threshold value to provide a binary selection; and
selecting, based on the binary selection, between the first task-specific function and the shared function.

25. The processor-implemented method of claim 20, further comprising:
determining a loss for first task-specific branch based on the output of the first task-specific branch; and
updating, using backpropagation, the at least one parameter of the first gating mechanism based on the loss.

26. The processor-implemented method of claim 20, further comprising:
obtaining training data for a second task in the layer of a second task-specific branch in the neural network, wherein the layer is further associated with a second gating mechanism configured to determine whether to process shared features of the training data for the second task using the shared function of the shared branch or second task-specific features of the training data for the second task using a second task-specific function, and wherein the second task-specific function is associated with one or more second task-specific channels of the second task-specific branch;
performing, based on a determination from the second gating mechanism, the shared function on the shared features of the training data for the second task using at least one of the one or more shared channels of the shared feature map to generate a second shared feature map;
performing, based on a determination from the second gating mechanism, the second task-specific function on the second task-specific features of the training data for the second task using at least one of the one or more second task-specific channels to generate a second task-specific feature map;
generating a second output for the second task-specific branch based on performing the shared function on the shared features of the training data and performing the second task-specific function on the second task-specific features; and
updating at least one parameter of the second gating mechanism based on the second output.

27. The processor-implemented method of claim 26, further comprising:
determining a second loss for the second task-specific branch based on the output of the second task-specific branch; and
updating, using backpropagation, the at least one parameter of the second gating mechanism based on the second loss.

28. The processor-implemented method of claim 26, wherein a first subset of the one or more shared channels is allocated to a first subset of the training data for the first task and a second subset of the one or more shared channels is allocated to the first subset of the training data for the second task.

29. The processor-implemented method of claim 26, wherein a classification of the first task is different from a classification of the second task.

30. The processor-implemented method of claim 20, further comprising:
based on the first gating mechanism, selecting between at least one channel of the one or more first task-specific channels and at least one corresponding channel of the one or more shared channels; and
pruning unselected channels based on the selection by the first gating mechanism.
